(19) United States
(12) Patent Application Publication
(10) Pub. No.: US 2018/0096067 A1
(43) Pub. Date: Apr. 5, 2018

(54) CREATION AND OPTIMIZATION OF RESOURCE CONTENTS

(71) Applicant: Searchmetrics GmbH, Berlin (DE)

(72) Inventors: Marcus Tober, Berlin (DE); Daniela Neumann, Berlin (DE)

(73) Assignee: Searchmetrics GmbH, Berlin (DE)

(21) Appl. No.: 15/284,739

(22) Filed: Oct. 4, 2016

(51) Int. Cl. G06F 17/30; G06Q 30/02

(52) U.S. Cl. CPC G06F 17/30864; G06F 3/0484; G06Q 30/0203

(57) ABSTRACT

A computer-implemented method of optimizing resource contents comprises, using pre-stored performance metrics: determining candidate topics related to received topics for the resource contents; and in case that topics selectable from the candidate topics, or added from additional topics are received, returning to determining one or more candidate topics; determining candidate questions relevant to at least one of the received topics; and receiving questions selectable from the candidate questions; determining candidate terms relevant to at least one of the received topics, and questions; and receiving terms selectable from the candidate terms; determining a candidate target quantity value for the resource contents based on at least one of the received topics, questions, and terms; and generating a brief for the resource contents based on at least one of the received topics, questions, and terms, a corresponding system, computing device and non-transitory computer-readable storage medium.

### BACKGROUND OF THE INVENTION

### Field of the Invention

The invention relates to a method, system, computing device and storage medium for creating and optimizing resource contents. More specifically, the invention relates to a method, system, computing device and storage medium for creating and optimizing resource contents in a network.

### Description of Prior Art

The World-Wide Web (www) comprises an indefinite number of webpages. Search engines crawl the webpages via the Internet and return, for user convenience, a list of webpages relevant to any particular search term, i. e. one or more keywords. Operators aiming to promote their webpages onto these lists of webpages create and optimize, using various techniques, their webpages for the search engines (search engine optimization, SEO). Recently, access to and usage of the World-Wide Web has moved from stationary personal computers to mobile computing devices.

Owing to the indefinite number of webpages and their ever changing contents, it is increasingly difficult to create and optimize webpages that match the users' search intention, and that are, thus, highly ranked by search engines in organic search results for relevant keywords.

The present invention overcomes present limitations and provides other advantages, as will become clearer to those skilled in the art from the present description.

### BRIEF SUMMARY OF THE INVENTION

According to an aspect of an embodiment, a computer-implemented method of optimizing resource contents may comprise: with a topic module, executing on one or more computing devices, automatically: determining, using pre-stored performance metrics, one or more candidate topics related to one or more received topics for the resource contents; and in case that one or more topics selectable from the one or more candidate topics, or added from one or more additional topics are received, returning to determining one or more candidate topics; with a question module, executing on the one or more computing devices, automatically: determining, using the pre-stored performance metrics, one or more candidate questions relevant to at least one of the one or more received topics; and receiving one or more questions selectable from the one or more candidate questions; with a term module, executing on the one or more computing devices, automatically: determining, using the pre-stored performance metrics, one or more candidate terms relevant to at least one of the one or more received topics, and one or more received questions; and receiving one or more terms selectable from the one or more candidate terms; with a target module, executing on the one or more computing devices, automatically: determining, using the pre-stored performance metrics, a candidate target quantity value for the resource contents based on at least one of the one or more received topics, one or more received questions, and one or more received terms; and with a brief module, executing on the one or more computing devices, automatically: generating a brief for the resource contents based on at least one of the one or more received topics, one or more received questions, and one or more received terms.

According to an aspect of another embodiment, a method may further comprise: with a project module, executing on one or more computing devices, automatically: receiving a project identifier identifying a project associated with the resource contents; receiving one or more topics related to the resource contents; receiving a market identifier identifying an intended market for the resource contents; and determining existing resource contents based on the received one or more topics.

According to an aspect of another embodiment, a method may further comprise: with the project module, automatically: in case that existing resource contents are determined, selecting an existing identifier identifying the existing resource contents; or in case that no existing resource contents are determined, determining, using the pre-stored performance metrics and based on at least one of the one or more received topics, one or more candidate resource identifiers for identifying the resource contents, and one or more candidate keywords relevant to at least one of the one or more received topics; receiving one or more resource identifiers selectable from the one or more candidate resource identifiers; and receiving one or more keywords selectable from the one or more candidate keywords.

According to an aspect of another embodiment, a method may further comprise: with the project module, automatically using the pre-stored performance metrics: determining one or more relevance values based on trends.

According to an aspect of another embodiment, a method may further comprise: with the project module, automatically using the pre-stored performance metrics:

determining one or more field resource contents having a performance higher than the existing resource contents.

According to an aspect of another embodiment, a method may further comprise: with the question module, automatically using the pre-stored performance metrics: filtering the one or more determined candidate questions.

According to an aspect of another embodiment, a method may further comprise: with the question module, automatically using the pre-stored performance metrics: ranking the one or more determined candidate questions.

According to an aspect of another embodiment, a method may further comprise: with the question module, automatically using the pre-stored performance metrics: grouping the one or more determined candidate questions around the one or more received topics.

According to an aspect of another embodiment, a method may further comprise: with the target module, automatically: determining, using the pre-stored performance metrics, a candidate target quality value for the resource contents based on at least one of the one or more received topics, one or more received questions, and one or more received terms.

According to an aspect of another embodiment, a method may further comprise: with the target module, automatically: receiving a target quantity value based on the candidate target quantity value; and/or receiving a target quality value based on the candidate target quality value, wherein: the brief is generated based on at least one of the one or more received topics, one or more received questions, one or more received terms, received target quantity value, and received target quality value.

According to an aspect of another embodiment, a method may further comprise: with a design module, executing on the one or more computing devices, automatically: determining, using the pre-stored performance metrics, one or more candidate designs relevant to at least one of the one or more received topics, one or more received questions, and one or more received terms; and receiving one or more designs selectable from the one or more candidate designs, wherein: the brief is generated based on at least one of the one or more received topics, one or more received questions, one or more received terms, and one or more received designs.

According to an aspect of another embodiment, a method may further comprise: with a structural element module, executing on the one or more computing devices, automatically: determining, using the pre-stored performance metrics, one or more candidate structural elements relevant to at least one of the one or more received topics, one or more received questions, and one or more received terms; and receiving one or more structural elements selectable from the one or more candidate structural elements, wherein: the brief is generated based on at least one of the one or more received topics, one or more received questions, one or more received terms, and one or more received structural elements.

According to an aspect of another embodiment, a method may further comprise: with a supplementary resource module, executing on the one or more computing devices, automatically: determining, using the pre-stored performance metrics, one or more candidate supplementary resources relevant to at least one of the one or more received topics, one or more received questions, and one or more received terms; and receiving one or more supplementary resource identifiers identifying one or more supplementary resources selectable from the one or more candidate supplementary resources, wherein: the brief is generated based on at least one of the one or more received topics, one or more received questions, one or more received terms, and one or more received supplementary resource identifiers.

According to an aspect of another embodiment, a method may further comprise: with a communications module, executing on the one or more computing devices, automatically: communicating the brief to a client computing device.

According to an aspect of another embodiment, in a method, the pre-stored performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate.

According to an aspect of another embodiment, in a method, the pre-stored performance metrics may comprise one or more context-related performance metrics relating to one or more contextual networks.

According to an aspect of another embodiment, a system for optimizing resource contents may comprise: one or more processors, when executing on one or more computing devices, being suitable for performing operation, and the operations may comprise: determining, using pre-stored performance metrics, one or more candidate topics related to one or more received topics for the resource contents; and in case that one or more topics selectable from the one or more candidate topics, or added from one or more additional topics are received, returning to determining one or more candidate topics; determining, using the pre-stored performance metrics, one or more candidate questions relevant to at least one of the one or more received topics; and receiving one or more questions selectable from the one or more candidate questions; determining, using the pre-stored performance metrics, one or more candidate terms relevant to at least one of the one or more received topics, and one or more received questions; and receiving one or more terms selectable from the one or more candidate terms; determining, using the pre-stored performance metrics, a candidate target quantity value for the resource contents based on at least one of the one or more received topics, one or more received questions, and one or more received terms; and generating a brief for the resource contents based on at least one of the one or more received topics, one or more received questions, and one or more received terms.

According to an aspect of yet another embodiment, a computing device for optimizing resource contents may comprise: one or more processors, configured to perform operations; and a memory, coupled to the one or more processors and comprising instructions to cause, when executing on the one or more processors, the computing device to perform operations, comprising: determining, using pre-stored performance metrics, one or more candidate topics related to one or more received topics for the resource contents; and in case that one or more topics selectable from the one or more candidate topics, or added from one or more additional topics are received, returning to determining one or more candidate topics; determining, using the pre-stored performance metrics, one or more candidate questions relevant to at least one of the one or more received topics; and receiving one or more questions selectable from the one or more candidate questions; determining, using the pre-stored performance metrics, one or more candidate terms relevant to at least one of the one or more received topics, and one or more received questions; and receiving one or more terms selectable from the one or more candidate terms; determining, using the pre-stored performance metrics, a candidate target quantity value for the resource contents based on at least one of the one or more received topics, one or more received questions, and one or more received terms; and generating a brief for the resource contents based on at least one of the one or more received topics, one or more received questions, and one or more received terms.

According to an aspect of another embodiment, in a computing device, the memory may further comprise instructions to cause the computing device to perform further operations, comprising: receiving a project identifier identifying a project associated with the resource contents; receiving one or more topics related to the resource contents; receiving a market identifier identifying an intended market for the resource contents; and determining existing resource contents based on the received one or more topics.

According to an aspect of another embodiment, in a computing device, the memory may further comprise instructions to cause the computing device to perform further operations, comprising: in case that existing resource contents are determined, selecting an existing identifier identifying the existing resource contents; or in case that no existing resource contents are determined, determining, using the pre-stored performance metrics and based on at least one of the one or more received topics, one or more candidate resource identifiers for identifying the resource contents, and one or more candidate keywords relevant to at least one of the one or more received topics; receiving one or more resource identifiers selectable from the one or more candidate resource identifiers; and receiving one or more keywords selectable from the one or more candidate keywords.

According to an aspect of another embodiment, in a computing device, the memory may further comprise instructions to cause the computing device to perform further operations, comprising: determining one or more relevance values based on trends.

According to an aspect of another embodiment, in a computing device, the memory may further comprise instructions to cause the computing device to perform further operations, comprising: determining one or more field resource contents having a performance higher than the existing resource contents.

According to an aspect of another embodiment, in a computing device, the memory may further comprise instructions to cause the computing device to perform further operations, comprising: filtering the one or more determined candidate questions.

According to an aspect of another embodiment, in a computing device, the memory may further comprise instructions to cause the computing device to perform further operations, comprising: ranking the one or more determined candidate questions.

According to an aspect of another embodiment, in a computing device, the memory may further comprise instructions to cause the computing device to perform further operations, comprising: grouping the one or more determined candidate questions around the one or more received topics.

According to an aspect of another embodiment, in a computing device, the memory may further comprise instructions to cause the computing device to perform further operations, comprising: determining, using the pre-stored performance metrics, a candidate target quality value for the resource contents based on at least one of the one or more received topics, one or more received questions, and one or more received terms.

According to an aspect of another embodiment, in a computing device, the memory may further comprise instructions to cause the computing device to perform further operations, comprising: receiving a target quantity value based on the candidate target quantity value; or receiving a target quality value based on the candidate target quality value, wherein: the brief is generated based on at least one of the one or more received topics, one or more received questions, one or more received terms, received target quantity value, and received target quality value.

According to an aspect of another embodiment, in a computing device, the memory may further comprise instructions to cause the computing device to perform further operations, comprising: determining, using the pre-stored performance metrics, one or more candidate designs relevant to at least one of the one or more received topics, one or more received questions, and one or more received terms; and receiving one or more designs selectable from the one or more candidate designs, wherein: the brief is generated based on at least one of the one or more received topics, one or more received questions, one or more received terms, and one or more received designs.

According to an aspect of another embodiment, in a computing device, the memory may further comprise instructions to cause the computing device to perform further operations, comprising: determining, using the pre-stored performance metrics, one or more candidate structural elements relevant to at least one of the one or more received topics, one or more received questions, and one or more received terms; and receiving one or more structural elements selectable from the one or more candidate structural elements, wherein: the brief is generated based on at least one of the one or more received topics, one or more received questions, one or more received terms, and one or more received structural elements.

According to an aspect of another embodiment, in a computing device, the memory may further comprise instructions to cause the computing device to perform further operations, comprising: determining, using the pre-stored performance metrics, one or more candidate supplementary resources relevant to at least one of the one or more received topics, one or more received questions, and one or more received terms; and receiving one or more supplementary resource identifiers identifying one or more supplementary resources selectable from the one or more candidate supplementary resources, wherein: the brief is generated based on at least one of the one or more received topics, one or more received questions, one or more received terms, and one or more received supplementary resource identifiers.

According to an aspect of another embodiment, in a computing device, the memory may further comprise instructions to cause the computing device to perform further operations, comprising: communicating the brief to a client computing device.

According to an aspect of another embodiment, in a computing device, the pre-stored performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate.

According to an aspect of another embodiment, in a computing device, the pre-stored performance metrics may comprise one or more context-related performance metrics relating to one or more contextual networks.

According to an aspect of yet another embodiment, a non-transitory computer-readable storage medium may comprise instructions causing a system to perform operations for optimizing resource contents, and the operations may comprise: determining, using pre-stored performance metrics, one or more candidate topics related to one or more received topics for the resource contents; and in case that one or more topics selectable from the one or more candidate topics, or added from one or more additional topics are received, returning to determining one or more candidate topics; determining, using the pre-stored performance metrics, one or more candidate questions relevant to at least one of the one or more received topics; and receiving one or more questions selectable from the one or more candidate questions; determining, using the pre-stored performance metrics, one or more candidate terms relevant to at least one of the one or more received topics, and one or more received questions; and receiving one or more terms selectable from the one or more candidate terms; determining, using the pre-stored performance metrics, a candidate target quantity value for the resource contents based on at least one of the one or more received topics, one or more received questions, and one or more received terms; and generating a brief for the resource contents based on at least one of the one or more received topics, one or more received questions, and one or more received terms.

Creating, or generating, and optimizing resource contents are challenges particular to the Internet. The present invention can enable a user, for example an operator of a large number of resources such as webpages, to control creation of new resource contents. Moreover, it can enable the user to control optimization of existing resource contents. In more detail, the present invention may guide the user through the process of creating and/or optimizing resource contents, wherein the process may use a topic graph. Thus, the present invention can enable the user to cope with the creation and optimization of the resource contents although technical, administrative or financial means may be limited. Further, the present invention can enable the user to concentrate on particular resource contents within the large body of resource contents having best prospects. Furthermore, the present invention can enable the user to save time and/or to reduce costs.

The object and advantages of the embodiments will be realized and achieved at least by steps, elements, features and combinations defined in the claims. Thus, this brief summary and the following detailed description are exemplary and explanatory, and are not restrictive of the invention as defined in the claims.

### BRIEF DESCRIPTION OF THE SEVERAL VIEWS OF THE DRAWING

The enclosed drawing depicts various aspects of some embodiments, and is not restrictive of the invention as defined in the claims:

FIG. 1 shows a typical computer network architecture 1 implementing the present invention;

FIG. 2 shows a typical computer device architecture 10 implementing the present invention;

FIG. 3 shows typical search engine results 2 implementing the present invention;

FIG. 4 shows a resource management architecture 3 implementing the present invention;

FIG. 5 shows a flow chart of a pre-process 4 for optimizing resource contents in a network according to an embodiment of the present invention;

FIG. 6 shows a simplified flow chart of a process 5 for optimizing resource contents in a network according to an embodiment of the present invention;

FIG. 7 shows a flow chart of a process 6 for creating or optimizing resource contents in a network according to an embodiment of the present invention; and

FIGS. 8 to 16 show simplified exemplary screenshots of a process for creating or optimizing resource contents in a network according to an embodiment of the present invention.

### DETAILED DESCRIPTION OF THE INVENTION

A preferred embodiment of the invention is now described in detail. Referring to the drawing, like reference numbers indicate like parts throughout the views. The drawing shows diagrammatic and schematic representations of some embodiments, is not necessarily drawn to scale, and is not restrictive of the invention. As used in the description and claims, the meaning of “a”, “an” and “the” includes plural reference unless the context clearly dictates otherwise.

As used herein, the term “computer network” generally refers to a plurality of interconnected computing devices such as desktop computers, laptop computers, mobile devices like tablet computers, smart phones and smart watches, and servers, interconnected directly or, via network devices such as hubs, routers, switches and gateways, indirectly, for example the Internet. The computer network may comprise wire-based or wireless connections, or both.

As used herein, the term “resource” generally refers to an information source, for example a document such as a static document like hypertext markup language (html) document or dynamically generated document like PHP: Hypertext Preprocessor (php) document, or a software application, such as a software application for a mobile device (mobile app, app), located in one or more computing devices and being accessible, using an identifier of the resource, via the computer network. The term “target resource” generally refers to a resource under test, whereas the term “field resource” generally refers to a resource serving as reference.

As used herein, the term “universal resource locator (URL)” generally refers to an identifier to the resource, specifying its location on the computer network and a mechanism for retrieving it.

As used herein, the term “page” generally refers to a single-page resource. Pages may have different lengths.

As used herein, the term “webpage” generally refers to a page in the World-Wide Web (www).

As used herein, the term “resource contents” generally refers to contents of a resource. The contents may comprise a resource title and a resource corpus. The contents may be comprised of at least one of textual contents, graphical contents, imagery contents, audio contents, and video contents, for example. The resource contents may be intended for a particular market. The market may be defined by a given country and/or given language.

As used herein, the term “contents score” generally refers to a rating of the quality, relevance and originality of the resource contents and, hence, its utility and usefulness. Thus, the contents score may be comprised of at least one of quality score, relevance score and originality score. Further, the rating for textual contents may involve validity and correctness of the contents in a given language, and the contents score may be comprised of at least one of quality score, relevance score, originality score and language score. The term “target contents score” or “target quality value” generally refers to a proposed or desired contents score of resource contents to be created, for example composed or written.

As used herein, the term “contents length” generally refers to an amount of the resource contents. The term “target contents length” or “target quantity value” generally refers to a proposed or desired contents length of resource contents to be created.

As used herein, the terms “content strategy brief”, “brief” and “briefing” refer to a proposal for a writer to create or optimize resource contents. The proposal is generated based on and comprises requirements of the resource contents, such as a contents topic, target quality value and target quantity value, and additional information, such as questions, trends, for example forthcoming events, holidays, seasons and festivities, and supplementary resources, for example media and video, relevant to and/or helpful for creation of the proposed resource contents.

As used herein, the term “site” generally refers a plurality of pages accessible via a common domain or subdomain name. Sites are typically operated by companies, governments, organizations, and private individuals, for example. The term target site generally refers to a site under test, whereas the term field site generally refers to a site serving as reference.

As used herein, the term “website” generally refers to a site in the World-Wide Web.

As used herein, the term “network” generally refers to a plurality of resources made available to users via a computer network. The World-Wide Web, for example, is a network.

As used herein, the term “design” generally refers to appearance of the resource, i. e. the presentation of the resource contents. The design determines arrangement of elements constituting the resource contents. The design is based on prescribed structural elements, such as textual elements, for example title elements, heading elements and paragraph elements, and frame elements. As used herein, the term “title” may refer a short textual element shown in a top horizontal bar of a webpage, whereas the term “heading” may refer to a short textual element in a window of the webpage preceding the contents or a paragraph for attracting attention and/or providing guidance, for example. A design may be represented by a template, i. e standardized resource, or master resource, defining layout and/or style to be used for the resource contents.

As used herein, the term “Lorem Ipsum” generally refers to a placeholder or filler in the design for a textual element that has not been created, yet.

As used herein, the term “keyword” generally refers to a term capturing the essence of a topic of interest or topic of a resource. The keyword may, for example, comprise a word or compound word. The term “commercial keyword” generally refers to a type of keyword having a high probability of bringing prospect customers to a page or site. The term “transactional keyword” generally refers to a type of keyword, like “buy” and “subscribe”, having a high probability of bringing determined customers to a page or site. Based on user intention, transactional keywords may be further classified into subcategories, or “buying cycle categories”, comprising “awareness”, “evaluation” or “consideration”, “decision” and “retention”. The term “informational keyword” generally refers to a type of keyword, like “what” or “how”, indicating search for information and having a low probability of generating revenue. The term “navigational keyword” generally refers to a type of keyword, like a company or brand name, indicating a navigational search for merely finding the page or site of this company or product.

As used herein, the term “topic cluster” generally refers to a cluster of similar keywords. The name of a topic cluster may result from the most frequent keyword in a cluster of similar keywords.

As used herein, the term “topic graph” refers to a representation, wherein each topic is represented by a node comprising one or more properties of the topic.

As used herein, the term “term frequency-inverse document frequency”, or “tf-idf” for short, is a numerical statistic intended to reflect importance of a particular term in a corpus of text or collection of documents. It is a function, such a product, of two statistics: term frequency and inverse document frequency: The term “term frequency” (tf) refers to the number of occurrences of the particular term in a document; wherein the weight of the term in a particular document is proportional to its term frequency. The term “inverse document frequency” (idf) refers an inverse of the number of all documents wherein the particular term occurs, thus, quantifying specificity of the term: wherein weights of very frequently occurring terms such as common terms, for example “a”, “the”, “is” and “and”, are diminished, and, thus, weights of rarely occurring terms are increased.

As used herein, the term “Word2Vec” generally refers to distinct models, comprising the continuous bag-of-words (CBOW) model and the continuous skip-gram model, for producing word embeddings in natural language processing (NLP) by taking a large corpus of text as input and producing a high-dimensional space wherein each unique word in the corpus is assigned to a corresponding word vector in the space. The word vectors are positioned in the space such that words that share common contexts in the corpus are located in close proximity to one another in the space. The models may be implemented by shallow, two-layer neural networks trained to reconstruct linguistic contexts of words.

As used herein, the term “organic search” generally refers to searching, in response to a query comprising one or more keywords (keyword query), relevant information. A search usually comprises adding attribution information, then filtering it, and then sorting it. Search algorithms comprise the CheiRank (sorting) algorithm and PageRank (sorting) algorithm. Search algorithms may analyse and/or exploit user behavior, for example length of stay on and return rate from a search result. The results of the organic search are generally ranked by relevance to the query.

As used herein, the term “search engine” generally refers to a software application for searching information on a network using organic search. Search engines include Google.com, Baidu.com and Yandex.com.

As used herein, the term “crawler” generally refers to a software application executable on a computing device for systematically browsing a network, typically for indexing sites for a search engine.

As used herein, the term “browser” generally refers to a software application executable on a computing device for enabling a computer user to navigate, or surf, a network.

As used herein, the term “search engine results page(s) (SERP(s))” generally refers to one or more pages generated by a search engine in response to a query received from a user via a computing device, returned to the computer device and displaying the ranked results in a browser on the computing device. In addition to results of the organic search, the pages typically further comprise sponsored results, i. e. advertisements relating to the query and paid for by advertisers (keyword advertising).

As used herein, the term “search engine marketing (SEM)” generally refers to marketing on search engine results pages, like keyword advertising.

As used herein, the term “conversion” generally refers to a user decision resulting in an operator-intended or marketing-intended action, such as a transaction, e. g. purchase.

As used herein, the term “cost per click (CPC)” refers to the cost in pay-per-click (PPC) marketing, a type of paid marketing where the advertiser has to pay to the affiliate when the user follows a link in the advertiser's advertisement. The advertisement may be one of the sponsored results, for example.

As used herein, the term “social network” generally refers to a network, like Facebook.com and Twitter.com, enabling its users to upload and consume, hence, share contents like messages, audio contents or video contents. Users may provide feedback on the contents by posting comments and sending social signals, like Facebook's Likes.

As used herein, the term “social media marketing (SMM)” generally refers to marketing on social networks, like viral videos.

As used herein, the term “marketplace” generally refers to a network, like Amazon.com and Tmall.com, offering products and services for rent or sale. Typically, a marketplace comprises a plurality of resources, each of which being dedicated to one or more products or services. Thus, a marketplace, for example, may comprise hundreds, thousands or millions of resources.

As used herein, the term “video platform” generally refers to a network, like Youtube.com and Vimeo.com, enabling its users to upload and consume, and, hence, share video contents.

As used herein, the term “app store” generally refers to a network, like Apple's iTunes App Store and Google's Play Store, enabling developers to distribute their software applications for computer devices, for example mobile apps.

As used herein, the term “link building” generally refers to methods aiming to increase the number and quality links on pages pointing to the page or site.

As used herein, the term “search engine optimization (SEO)” generally refers to methods aiming to improve the position of a page or site in the ranked results. The methods include direct on-page optimization amending the page or site itself, and indirect off-page optimization including link building, search engine marketing, social media marketing.

As used herein, the term “contextual network”, or content network, generally refers to a subnetwork of related resources in a network, the subnetwork providing services, like search engines, or contents, like social networks, marketplaces, video platforms and app stores. Typically, contextual networks, like Google AdWords and Facebook Ads, place context-specific advertisement across their pages.

As used herein, the term “performance” generally refers to a network-specific resource and its utility, usefulness and, hence, score and ranking. The performance of a target resource may be represented relative to the performance of a field resource.

As used herein, the term “performance metrics” generally refers to a network-specific resource and its metrics. The term keyword-related performance metrics generally refers to a metrics relating to a keyword, like search volume of the keyword and cost-per-click of the keyword. The term traffic-related performance metrics generally refers to a metrics relating to traffic, like traffic volume of the resource and traffic speed of the resource. The term context-related performance metrics generally refers to a metrics relating to a contextual network, like volume of social signals.

As used herein, the term “performance potential”, or “potential performance”, generally refers to a network-specific resource and its ability to increase its utility and usefulness, and to climb in scores and rankings. Thus, a resource being already at the top of a ranking or most popular has no potential to climb further. The performance potential of a target resource may be represented relative to the performance of a field resource.

For analyzing resource contents such as contents of electronic resources or digital resources like webpages, software applications, apps and app stores in a network such as the www, a computer such as a server computer coupled to the network may comprise a processor such as microprocessor, configured to perform operations; and a memory such as main memory, coupled to the processor and comprising instructions such as machine instructions. The instructions, when executed in the computer, i. e. by the processor, may cause the operations of crawling the network and acquiring contents from the resources in the network; determining performance metrics, such as keywords, search volumes of the keywords, costs-per-click of the keywords, traffics volumes of the resources, traffic speeds of the resources, context-related performance metrics relating contextual networks such as social networks like Facebook.com and marketplace like Amazon.com, volumes of social signals of the resources, numbers of backlinks to the resources, ratings of the resources, search-engine-optimization values of the resources, and bounce rates and click-through rates, characterizing the resources; and storing the performance metrics in the memory, for example in a data base in the memory.

For creating or optimizing resource contents such as contents of electronic resources or digital resources like webpages, software applications, apps and app stores in a network such as the www, a computer such as a server computer coupled to the network may comprise a processor such as microprocessor, configured to perform operations; and a memory such as main memory, coupled to the processor and comprising instructions such as machine instructions. The instructions, when executed in the computer, i. e. by the processor, may cause the operations of receiving, for example from a user via a web browser on another computer such as client computer, one or more received topics for resource contents, determining, using the pre-stored performance metrics, one or more candidate topics related to the one or more received topics for the resource contents; in case that one or more topics selectable from the one or more candidate topics, or added from one or more additional topics are received, returning to determining one or more candidate topics; determining, using the pre-stored performance metrics, one or more candidate questions relevant to at least one of the one or more received topics; and receiving one or more questions selectable from the one or more candidate questions; determining, using the pre-stored performance metrics, one or more candidate terms relevant to at least one of the one or more received topics, and one or more received questions; receiving one or more terms selectable from the one or more candidate terms; determining, using the pre-stored performance metrics, a candidate target quantity value for the resource contents based on at least one of the one or more received topics, one or more received questions, and one or more received terms; and generating a brief for the resource contents based on at least one of the one or more received topics, one or more received questions, and one or more received terms.

The instructions may cause the operations of outputting the performance metrics. The performance metrics may be suitably represented, for example, as bar graphs, pie charts, bubble charts, traffic-light rating like red amber green (RAG) rating or any combination thereof. The output may be presented to the user via the web browser on the other computer.

The instructions may cause the operations of creating or optimizing the resource contents. The resource contents may be created or optimized automatically, semi-automatically or manually.

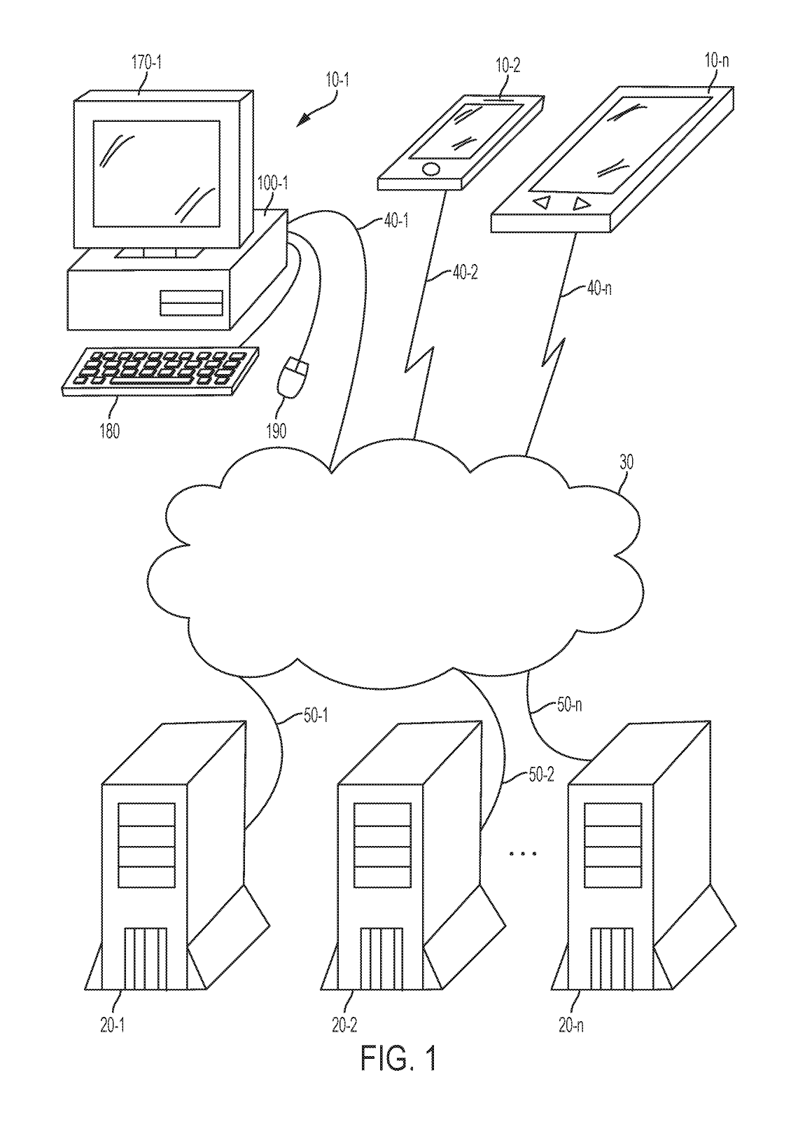

FIG. 1 shows a typical computer network architecture 1 implementing the present invention. The typical computer network architecture 1 may comprise a plurality of client computing devices 10-1, . . . 10-n, a plurality of server computing devices 20-1, . . . 20-n and a network 30 such as the Internet.

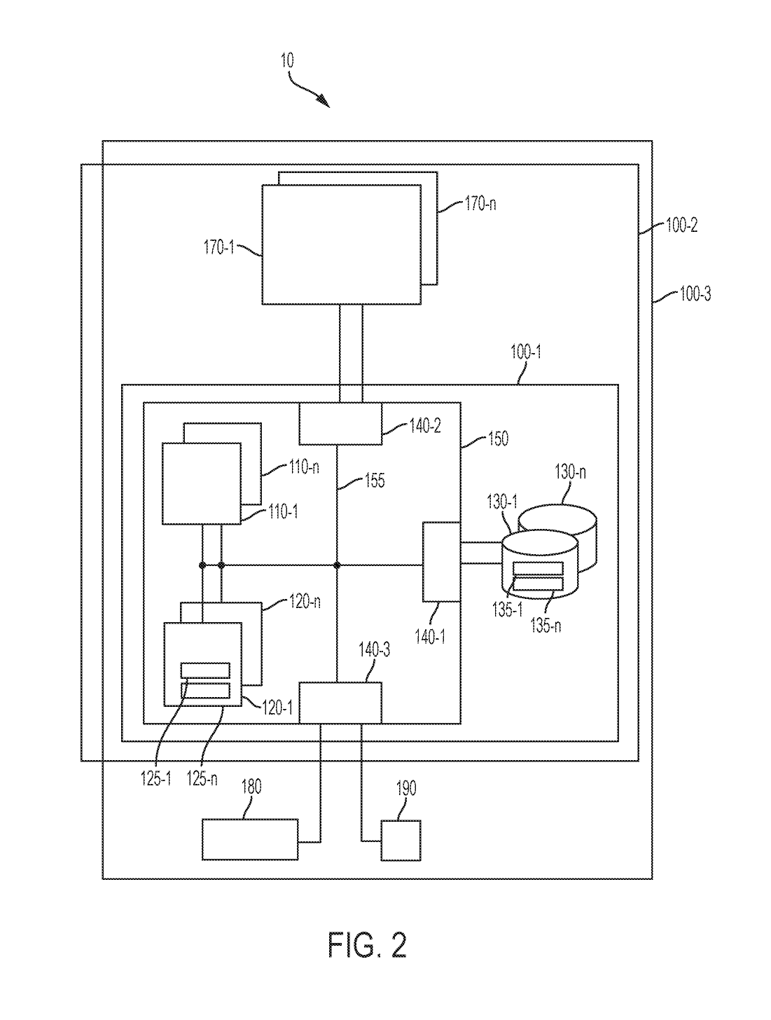

The plurality of client computing devices 10-1, . . . 10-n may comprise one or more stationary computing devices 10-1. One or more of the stationary computing devices 10-1 may, for example, comprise a desktop computer 100-1, a display 170-1 coupled to the desktop computer 100-1, an input device 180 such as a keyboard coupled to the desktop computer 100-1 and a pointing device 190 such as a mouse 190, joystick, trackball and touchpad coupled to the desktop computer 100-1. One or more of the stationary computing devices 10-1 may be coupled to the network 30 via a connection such as wire-based connection 40-1. The plurality of client computing devices 10-1, . . . 10-n may comprise one or more mobile computing devices 10-2, . . . 100-n such as a smart phone 10-2 or a tablet computer 10-n. One or more of the mobile computing devices 10-2, . . . 10-n may be coupled to the network 30 via a connection such as wireless connection 40-1, 40-n. The client computing devices 10-1, . . . 10-n may, for example, be implemented by a typical computer device architecture 10 as described with reference to FIG. 2.

The plurality of server computing devices 20-1, . . . 20-n may, for example, comprise one or more tower servers, one or more rack servers, or any combination thereof. One or more of the plurality of server computing devices 20-1, . . . 20-n may be coupled to the network 30 via a connection such as wire-based connection 50-1, . . . 50-n. The server computing devices 20-1, . . . 20-n may, for example, be implemented by a typical computer device architecture 10 as described with reference to FIG. 2.

The network 30 may comprise one or more hubs, switches, routers and the like. Thus, users of the plurality of client computing devices 10-1, . . . 10-n may, for example, access software such as data or programs stored in plurality of server computing devices 20-1, . . . 20-n via the network 30.

FIG. 2 shows a typical computer device architecture 10 implementing the present invention. The typical computer device architecture 10 may comprise one or more processors 110-1, . . . 110-n, one or more memories 120-1, . . . 120-n coupled to the one or more processors 110-1, . . . 110-n, and one or more interfaces 140-1, . . . 140-3 coupled to the one or more processors 110-1, . . . 110-n.

The one or more processors 110-1, . . . 110-n may execute instructions of programs, for example, comprise a microprocessor, an application-specific integrated circuit (ASIC), an application-specific instruction set processor (ASIP), a digital signal processor (DSP), a co-processor, or any combination thereof. The one or more processors 110-1, . . . 110-n may, for example, comprise a single-core processor, multi-core processor such as quad-core processor, or any combination thereof. The one or more processors 110-1, . . . 110-n may, for example, be implemented by microcontrollers or field programmable gate arrays (FPGAs).

The one or more memories 120-1, . . . 120-n may store software items 125-1, . . . 125-n such as data or programs likes databases and, for example, comprise volatile memory such as random-access memory (RAM) and static RAM (SRAM), non-volatile memory such as read-only memory (ROM), electrically erasable programmable ROM (EEPROM) and Flash memory, or any combination thereof. The one or more interfaces 140-1, . . . 140-3 may, for example, comprise parallel interfaces, serial interfaces, universal serial bus (USB) interfaces, or any combination thereof.

The one or more processors 110-1, . . . 110-n, one or more memories 120-1, . . . 120-n and one or more interfaces 140-1, . . . 140-3 may be arranged on a circuit board such as printed circuit board (PCB) 150 comprising connections such as a bus 155 coupling the one or more processors 110-1, . . . 110-n, one or more memories 120-1, . . . 120-n and one or more interfaces 140-1, . . . 140-3.

The typical computer device architecture 10 may comprise one or more data storages 130-1, . . . 130-n such as hard disk drives (HDDs, hard disks, hard drives), solid-state drives (SSDs), Compact Disc ROM (CD-ROM) drives, or any combination thereof. The one or more data storages 130-1, . . . 130-n may store software items 135-1, . . . 135-n such as data or programs likes databases. The one or more data storages 130-1, . . . 130-n may, for example, comprise fixed data storages, removable data storages, or any combination thereof. The one or more data storages 130-1, . . . 130n may be coupled to the one or more processors 110-1, . . . 110-n via a storage interface 140-1 of the one or more interfaces 140-1, . . . 140-3.

The typical computer device architecture 10 may comprise one or more displays 170-1, . . . 170-n such as cathode ray tube (CRT) displays, liquid-crystal displays (LCDs), organic light-emitting diode (OLED) displays, or any combination thereof. The one or more data storages 170-1, . . . 170-n may be coupled to the one or more processors 110-1, . . . 110-n via a display interface 140-2 of the one or more interfaces 140-1, . . . 140-3.

The typical computer device architecture 10 may comprise an input device 180 such as a keyboard coupled to the one or more processors 110-1, . . . 110-n via a input interface 140-3 of the one or more interfaces 140-1, . . . 140-3. The typical computer device architecture 10 may comprise a pointing device 190 such as a mouse, joystick, trackball and touchpad coupled to the one or more processors 110-1, . . . 110-n via the input interface 140-3.

The desktop computer 100-1, for example, may comprise the one or more processors 110-1, . . . 110-n, one or more memories 120-1, . . . 120-n, one or more interfaces 140-1, . . . 140-3, PCB 150 and one or more data storages 130-1, . . . 130n. An all-in-one computer 100-2, for example, may comprise the one or more processors 110-1, . . . 110-n, one or more memories 120-1, . . . 120-n, one or more interfaces 140-1, . . . 140-3, PCB 150, one or more data storages 130-1, . . . 130n and one or more displays 170-1, . . . 170-n. A notebook computer 100-3, for example, may comprise the one or more processors 110-1, . . . 110-n, one or more memories 120-1, . . . 120-n, one or more interfaces 140-1, . . . 140-3, PCB 150, one or more data storages 130-1, . . . 130n, one or more displays 170-1, . . . 170-n, input device 180 and pointing device 190. The typical computer device architecture 10 may further comprise a power supply (not shown) such as mains adapter, battery, or any combination thereof.

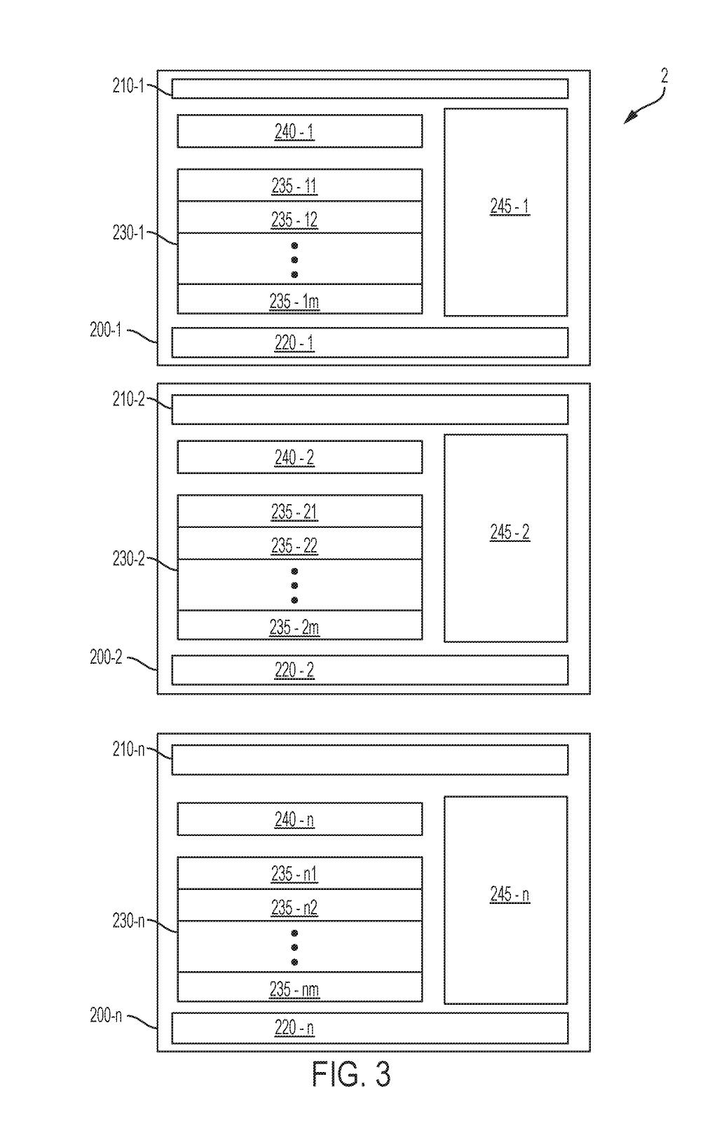

FIG. 3 shows typical search engine results 2 implementing the present invention. The typical search engine results 2 may comprise a plurality of on-screen SERPs 200-1, . . . 200-n comprising a first SERP 200-1, a second SERP 200-2 and subsequent SERP 200-n generated by a search engine.

Each of the plurality of SERPs 200-1, . . . 200-n may comprise a query section 210-1, . . . 210-n for receiving one or more keywords and one or more search instructions from a user. As shown in FIG. 3, the query section 210-1, . . . 210-n may be rectangular. It may extend partially or fully across the SERP 200-1, . . . 200-n. It may be arranged towards a top margin of the SERP 200-1, . . . 200-n.

Each of the plurality of SERPs 200-1, . . . 200-n may comprise a navigation section 220-1, . . . 220-n for receiving navigational instructions from the user, such as a plurality of on-screen buttons each of which being assigned on one of the plurality of SERPs 200-1, . . . 200-n. As shown in FIG. 3, the navigation section 220-1, . . . 220-n may be rectangular. It may extend partially or fully across the SERP 200-1, . . . 200-n. It may be arranged towards a bottom margin of the SERP 200-1, . . . 200-n.

Each of the plurality of SERPs 200-1, . . . 200-n may comprise an organic search result section 230-1, . . . 230-n for displaying one or more organic search results to the user. As shown in FIG. 3, the organic search result section 230-1, . . . 230-n may be rectangular. It may extend partially or fully along the SERP 200-1, . . . 200-n. It may be arranged towards a left margin of the SERP 200-1, . . . 200-n. The organic search result section 230-1, . . . 230-n may comprise a plurality of individual organic search result sections 235-11, . . . 235-1m, 235-21, . . . 235-2m, 235-n1, . . . 235-nm comprising a first individual organic search result section 235-11, 235-21, . . . 235-n1, a second individual organic search result section 235-12, 235-22, . . . 235-n2, and subsequent individual organic search result sections 235-1m, 235-2m, 235-nm. The plurality of organic search result sections 230-1, . . . 230-n may have different numbers m of individual organic search result sections 235-11, . . . 235-1m, 235-21, . . . 235-2m, 235-n1, . . . 235-nm. The search engine may rank the organic search results according to their relevance to the one or more keywords. The search engine may assign to each of the individual organic search result sections 235-11, . . . 235-1m, 235-21, . . . 235-2m, 235-n1, . . . 235-nm one of the organic search results. Thus, a most relevant organic search result may be assigned to the first individual organic search result section 235-11 on the first SERP 200-1, a second most relevant organic search result may be assigned to the second individual organic search result section 235-12 on the first SERP 200-1, an m-th most relevant organic search result may be assigned to the m-th individual organic search result section 235-1m on the first SERP 200-1, an (m+1)-th most relevant organic search result may be assigned to the first individual organic search result section 235-21 on the second SERP 200-2, and so on.

Traffic resulting from searches generally divides into, on the first SERP 200-1, 10% for the most relevant organic search result, 8% for the second most relevant organic search result, 6% for the third most relevant organic search result, 3% for the fourth most relevant organic search result, . . . 0.5% for the tenth most relevant organic search result, on the second SERP 200-2, 0.05% for the eleventh most relevant organic search result.

Performance potentials are generally, on the first SERP 200-1, 0% for both the most relevant organic search result and the second most relevant organic search result, in case of a navigational keyword 0% or in case of a transactional or informational keyword 10% for both the third and fourth most relevant organic search results, 15% for both the fifth and sixth most relevant organic search results, 25% for each of the seventh, eighth, ninth and tenth most relevant organic search results, and on the second SERP 200-2, 500% for both the eleventh and twelfth organic search results, i. e. a move from the second SERP 200-2 to the first SERP 200-1.

Each of the plurality of SERPs 200-1, . . . 200-n may comprise one or more sponsored search result sections 240-1, . . . 240-n for displaying one or more sponsored search results to the user. As shown in FIG. 3, the sponsored search result sections 240-1, . . . 240-n may be rectangular. They may extend partially or fully along the SERP 200-1, . . . 200-n. As shown in FIG. 3, the search result sections 240-1, . . . 240-n may be arranged towards the left margin of the SERP 200-1, . . . 200-n, or the right margin, for example.

Each of the plurality of SERPs 200-1, . . . 200-n may comprise one or more integration sections 245-1, . . . 245-n for displaying one or more search engine integrations, i. e. additional contents compiled and/or provided by the search engine, to the user. As shown in FIG. 3, the integration sections 245-1, . . . 245-n may be rectangular. They may extend partially or fully along the SERP 200-1, . . . 200-n. As shown in FIG. 3, the integration sections 245-1, . . . 245-n may be arranged towards the right margin of the SERP 200-1, . . . 200-n, or the left margin, for example.

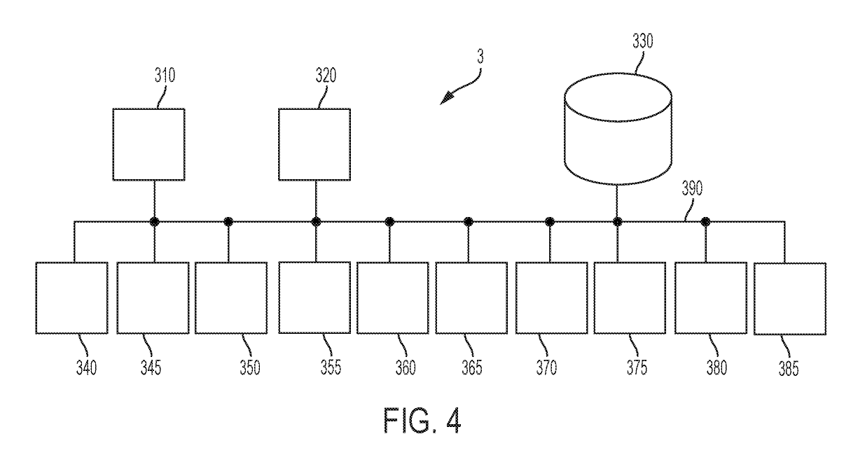

FIG. 4 shows a resource management architecture 3 implementing the present invention. The resource management architecture 3 may, for example, be implemented in a stand-alone resource management system, a content management system (CMS) or research tool, such as online research tool. The resource management architecture 3 may comprise a plurality of modules such as software modules, hardware modules, or any combination thereof. The plurality of modules may be executed on the one or more computing devices 10 such as server computing devices 20-1, . . . 20-n, or provided as a service, that may be implemented as a cloud service. The software modules may comprise programs such as machine code, or compiled or interpreted code. The hardware modules may comprise dedicated hardware such as ASICs and FPGAs. Two or more modules of plurality of modules may be coupled to each other via one or more connections such as a module bus 390.

The resource management architecture 3 may comprise a crawler module 310. The crawler module 310 may automatically crawl a network and acquire contents from one or more resources in the network, acquire the contents from an open repository of web crawl data such as CommonCrawl.org.

The resource management architecture 3 may comprise a determiner module 320. The determiner module 320 may automatically determine performance metrics characterizing each of the one or more resources of the crawled network.

The resource management architecture 3 may comprise a data base module 330. The data base module 330 may automatically store the determined performance metrics as pre-stored performance metrics.

The resource management architecture 3 may comprise a project module 340. The project module 340 may automatically receive a project identifier identifying a project associated with resource contents to be optimized. The project module 340 may automatically receive a market identifier identifying an intended market for the resource contents. The project module 340 may automatically receive one or more topics related to the resource contents. The project module 340 may automatically determine existing resource contents based on the received one or more topics. The project module 340 may automatically, in case that existing resource contents are determined, select an existing identifier identifying the existing resource contents, or, in case that no existing resource contents are determined, determine, using the pre-stored performance metrics and based on at least one of the one or more received topics, one or more candidate resource identifiers for identifying the resource contents, and one or more candidate keywords relevant to at least one of the one or more received topics. Preferably, the one or more candidate keywords may be relevant to performance, and, thus, may have a potential to optimize, i. e. increase, performance of the resource contents. The project module 340 may automatically receive one or more resource identifiers selectable from the one or more candidate resource identifiers. The project module 340 may automatically receive one or more keywords selectable from the one or more candidate keywords. Preferably, the one or more received keywords may also be relevant to performance, and, thus, may have the potential to optimize, i. e. increase, the performance of the resource contents.

The project module 340 may automatically determine, using the pre-stored performance metrics, one or more relevance values based on trends. The project module 340 may automatically determine, using the pre-stored performance metrics, one or more field resource contents having a performance higher than the existing resource contents.

The resource management architecture 3 may comprise a topic module 345. The topic module 345 may automatically determine, using pre-stored performance metrics, one or more candidate topics related to one or more received topics for the resource contents. The topic module 345 may automatically, in case that one or more topics selectable from the one or more candidate topics, or added from one or more additional topics are received, return to determining one or more candidate topics.

The resource management architecture 3 may comprise a question module 350. The question module 350 may automatically determine, using the pre-stored performance metrics, one or more candidate questions relevant to at least one of the one or more received topics. The question module 350 may automatically receive one or more questions selectable from the one or more candidate questions. The question module 350 may automatically, using the pre-stored performance metrics, filter the one or more determined candidate questions. The question module 350 may automatically rank the one or more determined or filtered candidate questions. The question module 350 may automatically group the one or more determined, filtered or ranked candidate questions around the one or more received topics.

The resource management architecture 3 may comprise a term module 355. The term module 355 may automatically determine, using the pre-stored performance metrics, one or more candidate terms relevant to at least one of the one or more received topics, and one or more received questions. The term module 355 may automatically receive one or more terms selectable from the one or more candidate terms.

The resource management architecture 3 may comprise a design module 360. The design module 360 may automatically determine, using the pre-stored performance metrics, one or more candidate designs relevant to at least one of the one or more received topics, one or more received questions, and one or more received terms, wherein a design determines an arrangement of elements constituting the resource contents. The design module 360 may automatically receive one or more designs selectable from the one or more candidate designs.

The resource management architecture 3 may comprise a structural element module 365. The structural element module 365 may automatically determine, using the pre-stored performance metrics, one or more candidate structural elements relevant to at least one of the one or more received topics, one or more received questions, and one or more received terms, wherein structural elements may comprise textual elements, title elements, heading elements and paragraph elements and frame elements, for example.

The structural element module 365 may automatically receive one or more structural elements selectable from the one or more candidate structural elements.

The resource management architecture 3 may comprise a supplementary resource module 370. The supplementary resource module 370 may automatically determine, using the pre-stored performance metrics, one or more candidate supplementary resources relevant to at least one of the one or more received topics, one or more received questions, and one or more received terms, wherein a supplementary resource may, for example, be media and video, relevant to and/or helpful for creation of the resource contents. The supplementary resource module 370 may automatically receive one or more supplementary resource identifiers identifying one or more supplementary resources selectable from the one or more candidate supplementary resources.

The resource management architecture 3 may comprise a target module 375. The target module 375 may automatically determine, using the pre-stored performance metrics, a candidate target quantity value for the resource contents based on at least one of the one or more received topics, one or more received questions, and one or more received terms. The target module 375 may automatically receive a target quantity value based on the candidate target quantity value. The target module 375 may automatically determine, using the pre-stored performance metrics, a candidate target quality value for the resource contents based on at least one of the one or more received topics, one or more received questions, and one or more received terms. The target module 375 may automatically receive a target quality value based on the candidate target quality value.

The pre-stored performance metrics may be relevant to and/or based on field resource contents being in competition with the resource contents, for example resource contents of one or more users competing with the user. For example, the field resource contents may belong to between 10 and 50, or 20 competitors of the user. The competitors and their resource contents may be dynamically determined.

The resource management architecture 3 may comprise a brief module 380. The a brief module 380 may generate a brief for the resource contents based on at least one of the one or more received topics, one or more received questions, one or more received terms, one or more received designs, one or more received structural elements, one or more received supplementary resource identifiers, received target quantity value, and received target quality value. A user, i. e. editior, of the resource management architecture 3 may influence generation of the brief, for example by selecting from determined candidates.

The resource management architecture 3 may comprise a communications module 385. The communications module 385 may automatically communicate the brief to a client computing device.

A user, i. e. writer such as freelance writer, of the client computing device may create or optimize the resource contents based on the brief. The resource management architecture 3 may determine compliance of the created or optimized resource contents with the brief, preferably while the user is creating or optimizing the resource contents, i. e. in real time. The performance metrics of a present version of the resource contents may be automatically determined using the determiner module 320. Thus, the user is enabled to ensure compliance of the resource contents with the brief.

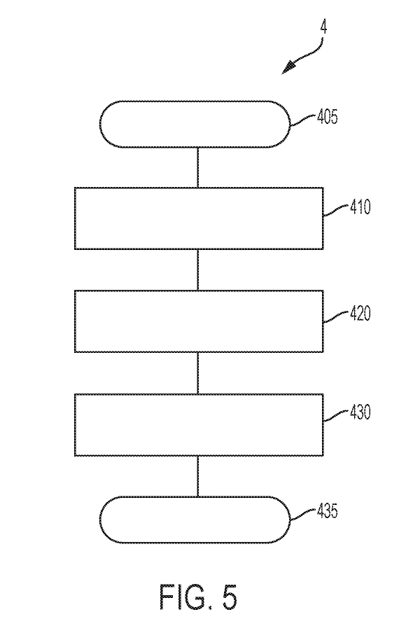

FIG. 5 shows a flow chart of a pre-process 4 for optimizing resource contents in a network according to an embodiment of the present invention. The pre-process 4 obtains performance metrics and stores same for subsequent optimization of the resource contents in the network.

The pre-process 4 for optimizing the resource contents in the network starts at step 405.

Following step 405, the pre-process 4 comprises step 410. In step 410, the pre-process 4 may automatically crawl the network and acquire resource contents from one or more resources in the network.

Following step 410, the pre-process 4 comprises step 420. In step 420, the pre-process 4 may automatically determine performance metrics characterizing each of one or more resources of the crawled network.

Following step 420, the pre-process 4 comprises step 430. In step 410, the pre-process 4 may automatically store the determined performance metrics as pre-stored performance metrics.

The pre-process 4 for analyzing the resources in the network ends at step 435.

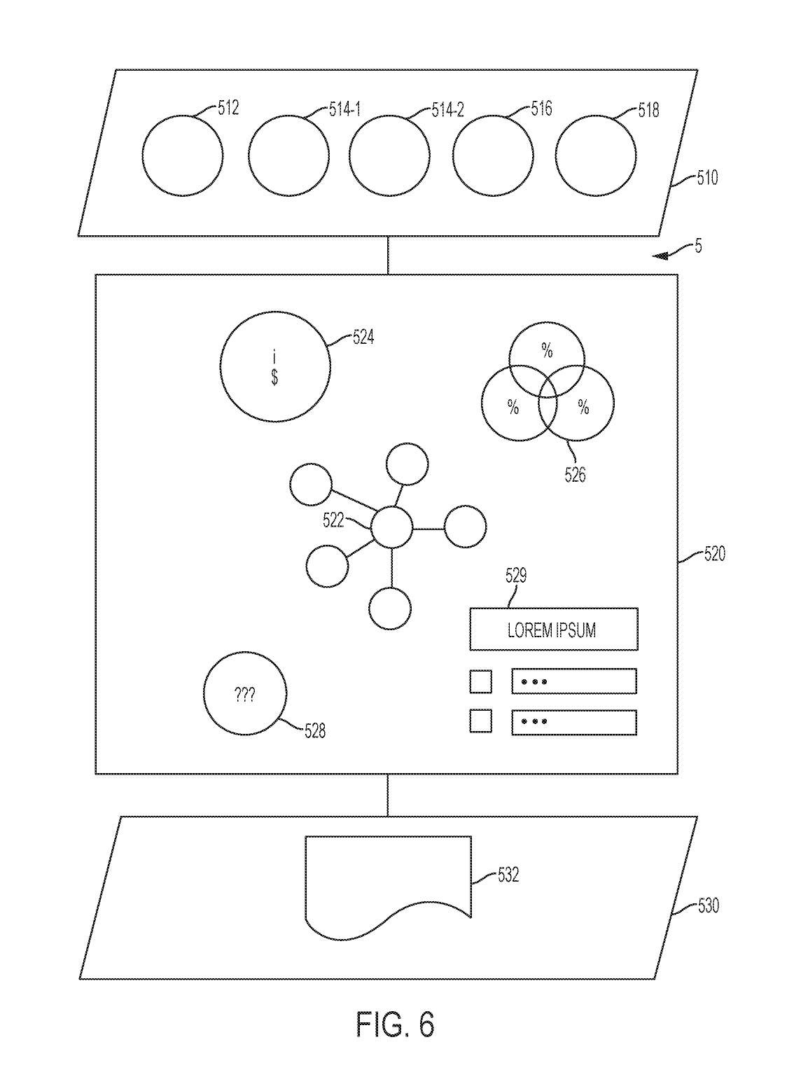

FIG. 6 shows a simplified flow chart of a process 5 for optimizing resource contents in a network according to an embodiment of the present invention.

The process 5 for optimizing resource contents in the network starts at step 510. In step 510, the process 5 may require user authentication from a user. The user authentication may be implemented as single-factor authentication, two-factor authentication or multi-factor authentication, for example. The process 5 may receive inputs 512, 514, 516, 518 from the user. A project input 512 may represent a project name, such as a business name. A market input 514 may represent a market name. Further, a brief input may represent a brief name. As shown in FIG. 6, the market input 514 may be comprised of a country input 514-1 representing a country name, for example “Canada”, and a language input 514-2 representing a name of a language in the country, for example “English”. A topic input 516 may represent a main topic name, being of central importance to the resource contents, for example “How to shrink jeans”, “How to bake pizza” or “Wedding dresses”. An identifier input 518 may represent an identifier of an existing resource, such as a URL of a webpage.

Following step 510, the process 5 comprises step 520. In step 520, the process 5 may guide the user through a data-driven process and generate a brief for creating or optimizing resource contents based on the inputs 512, 514-1, 514-2, 516, 518. The process may generate a sequence of data-driven suggestions in the field of topic relations 522, search intentions 524, performance metrics 526, topic-related questions 528 and resource design 529, for example. The process may iteratively adapt the suggestions. The topic relations 522 may represent a plurality of related-topics and their dependencies in a structured form, using a tree-structure, for example. The search intentions 524 may represent search queries and the type of query, i. e. a commercial search, a transactional search, an informational or a navigational search. The performance metrics 526 may be obtained by the pre-process 4. The topic-related questions 528 may be determined from common questions in search queries related to the topic(s). The resource design 529 may be determined from relevant organic search results for search queries related to the topic(s).

Following step 520, the process 5 comprises step 530. In step 530, the process 5 for optimizing resource contents in the network outputs the generated brief as an output 532 and ends. The output 532 may be in the form of a document, such as .doc, .docx or .pdf document, or webpage such as .HTML file, for example.

Thus, the process 5 for optimizing resource contents in a network provides the user, such as a content strategist, content marketing manager, online marketing manager, editor, chief editor, freelancer or owner of a small business, with a brief for creating contents for a new resource or optimizing contents of an existing resource, that will rank high in organic search results for the relevant topics and, thus, attract more visits of the resource, in a quick and reliable way, without manual or additional research. For focusing contents, the process 5 may determine particular aspects of a broad topic based on clusters of topics, top-relevant topics and search volume, for example. For determining and optimizing performance of the user's resources, the process 5 may identify keywords for which the resources rank high. For providing resource contents that meets intentions and expectations and are, hence, relevant to visitors, the process may identify questions about the topic(s) based on existing resources on the topic(s). For setting a target length, or target quantity, for the resource contents, the process 5 may determine an average length of the similar contents of existing resources. The process 5 may set the target length to between 50% and 100% or between 65% and 85%, or 75% of the average length. For setting a relevance, or target quality, for the resource contents, the process 5 may determine a value, such as degree in %, based on the highest ranking existing resources. For setting a design, the process 5 may determine a template based on designs of existing resources on the topic(s). The template may indicate types and/or amounts of contents such as text, graphics, images and video, and format and/or structure for the resource contents

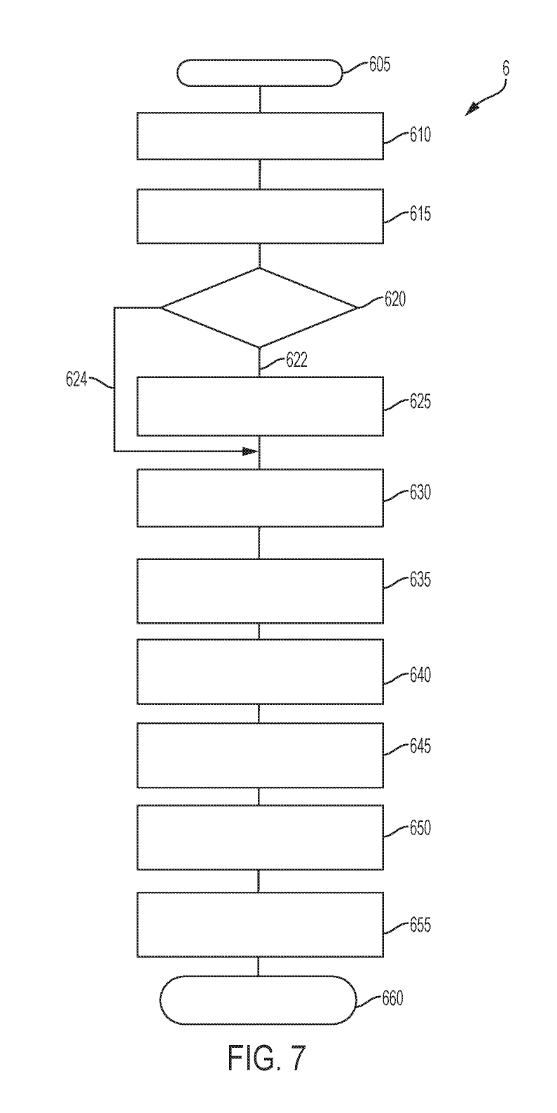

FIG. 7 shows a flow chart of a process 6 for creating or optimizing resource contents in a network according to an embodiment of the present invention.

The process 6 for creating or optimizing resource contents in the network starts at step 605. The process 6 may generate a brief for creating new resource contents for a specific indicator such as URL, creating new resource contents without indicator, or revising existing resource contents with a specific indicator.

Following step 605, the process 6 may comprise step 610. In step 610, the process 6 may require user authentication from a user.

Following step 605 or 610, the process 6 comprises step 615. In step 615, the process 6 receives an input from the user indicating whether the process 6 is to create new resource contents or to revise existing resource contents. Further, the process 6 receives inputs indicating a project, market, i. e. country and language, topic and briefing name. Furthermore, the process 6 determines whether resource contents have already been created for the topic. In case that resource contents has already been created for the topic, the process 6 may determines a best the resource comprising the best fitting contents and its identifier.

Following step 615, the process 6 comprises step 620. In step 620, the process 6 receives an input indicating whether the resource contents are with the specific indicator or without indicator. In case that the resource contents are with the specific indicator 622, the process 6 continues at step 625. In case that the resource contents are without indicator 624, the process 6 continues at step 630.

Following step 620, the process 6 comprises the step 625. In step 625, the process 6 determines, by extracting performance metrics such as search volumes and click-rate models from a repository of ranking data, keywords that are highly relevant to the topic and the specific identifier. The process may further determine seasonal opportunities and or areas where competitors are higher ranked. The process 6 receives input indicating selected keywords that describe the topic best, enhance understanding and/or avoid undesired side effects.

Following step 620 or 625, the process 6 comprises the step 630. In step 630, the process 6 determines, based on the topic, semantically related topics and their relations to each other. The process 6 receives input indicating selected topics or inputting new topics. As long as the process 6 receives inputs, it may iteratively determine the semantically related topics and their relations.

Following step 630, the process 6 comprises step 635. In step 635, the process 6 determines, based on the selected topics, relevant questions from the repository. The process may filter, rank and/or group the questions by relevance, based on performance metrics, for example. The process 6 receives input indicating selected questions that may assist in creating or optimizing the resource contents, e. g. by inspiring the writer.

Following step 635, the process 6 comprises step 640. In step 640, the process 6 determines terms for the selected topics based on the selected terms and/or questions. The terms may be determined using tf-idf analysis or Word2Vec modelling, for example. The process 6 receives input indicating selected terms that represent the demand for contents best and, thus, should be included in the resource contents.

Following step 640, the process 6 comprises step 645. In step 645, the process 6 determines structural elements such as titles and headlines for resource contents based on the selected topics, terms and/or questions. The structural elements may be normalized, i. e. converted into their base forms, and de-duplicated, i. e. duplicates may be removed. The process 6 receives input indicating selected structural elements that represent the intent for the resource contents to be created or optimized best.

Following step 645, the process 6 comprises step 650. In step 650, the process 6 determines supplementary resources such videos relevant to the resource contents based on the selected topics, terms, questions and/or structural elements. The process 6 receives input indicating selected supplementary that may further assist in creating or optimizing the resource contents, e. g. by inspiring the writer.

Following step 650, the process 6 comprises step 655. In step 655, the process 6 determines a target quantity and target quality based on similar contents of existing resources. The process 6 receives input indicating selected target quantity and target quality that meet predicted contents-specific expectations. The process may further receive input indicating related information, such as due date, selected writer and additional notes. The process may create the brief. The brief may be saved and/or send to the selected writer.

The process 6 for creating or optimizing resource contents in the network ends at step 660.

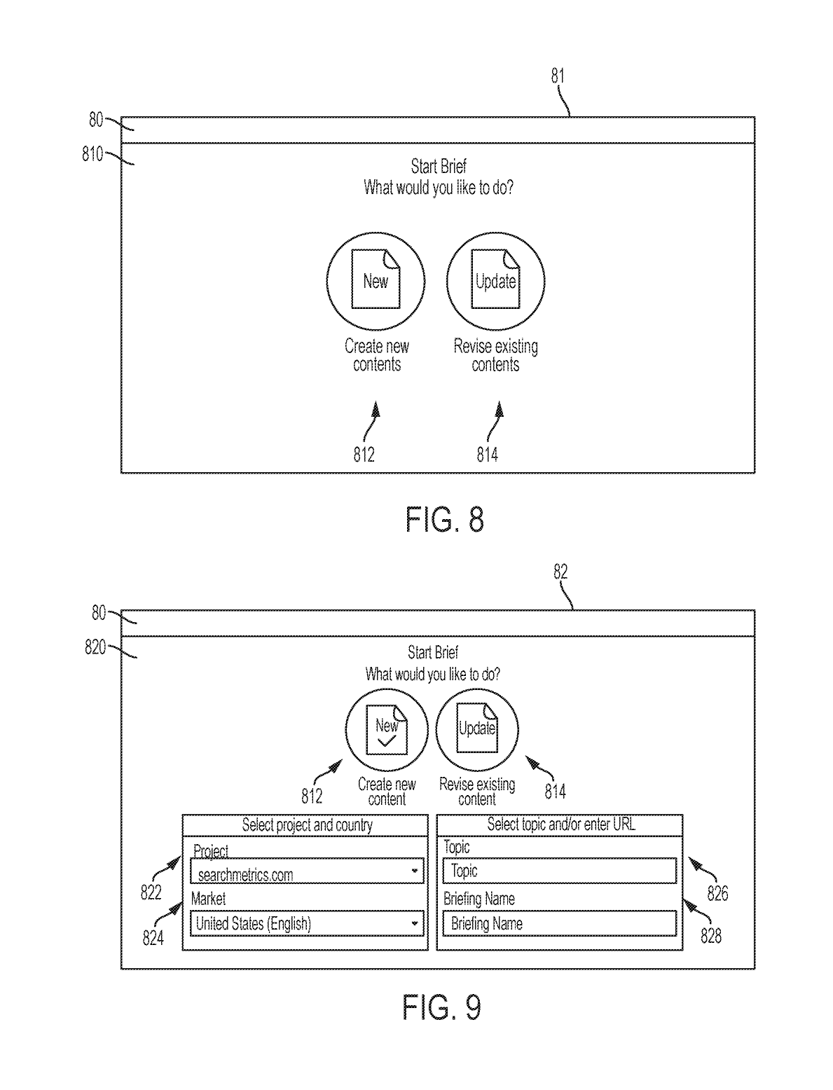

FIGS. 8 to 16 show simplified exemplary screenshots of a process for creating or optimizing resource contents in a network according to an embodiment of the present invention.

FIGS. 8 and 9 show simplified exemplary screenshots of the process 6 at the step 615 shown in FIG. 7.

As shown in FIG. 8, the process 6 provides, in step 615, a browser-capable webpage 81, comprising a corpus 810 and a top horizontal bar 80. The contents 810 comprises an input element 812 for indicating creation of new resource contents and an input element 814 for indicating revision of existing resource contents, and the process 6 awaits input from the user.

As shown in FIG. 9, in case that creation of new resource contents has been received, the process 6 provides, also in step 615, a browser-capable webpage 82, comprising a corpus 820 and a top horizontal bar 80. The contents 820 further comprises an input element 822 for indicating, i. e. selecting or inputting the project, an input element 824 for indicating, the market, i. e. country and language, an input element 826 for inputting, the topic, and an input element 828 for inputting the briefing name.

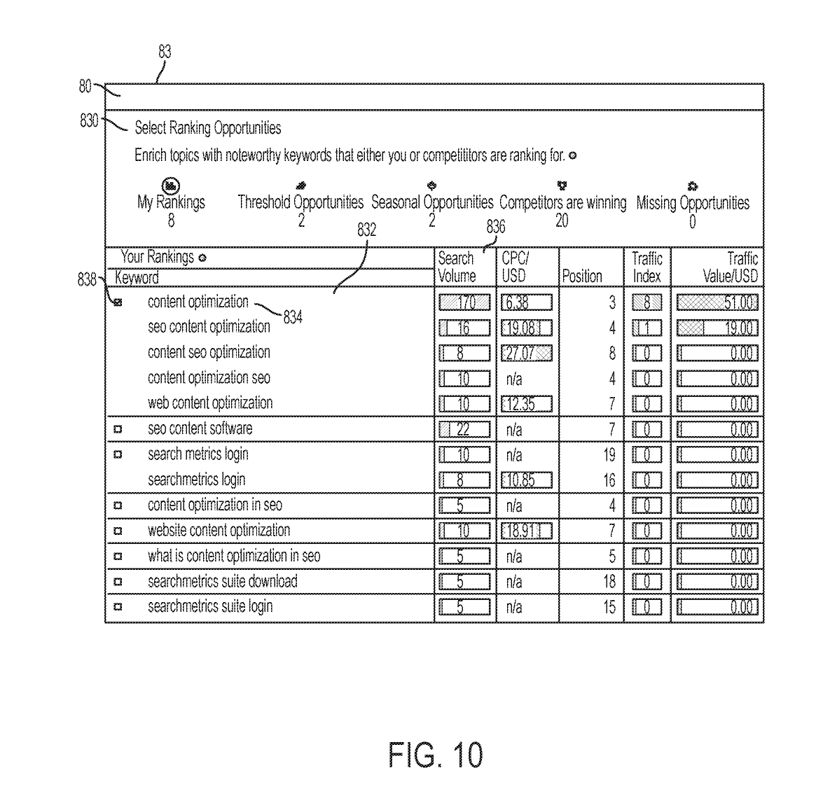

As shown in FIG. 10, in case that the resource contents are with the specific indicator, the process 6 provides, in step 625, a browser-capable webpage 83, comprising a corpus 830 and a top horizontal bar 80. The contents 830 comprise the keywords 834 with the performance metrics 836 and input elements 838 for selecting the keywords in a list 832. Further, the contents 830 may comprise, in a similar way, the seasonal opportunities and/or the areas where competitors are higher ranked.

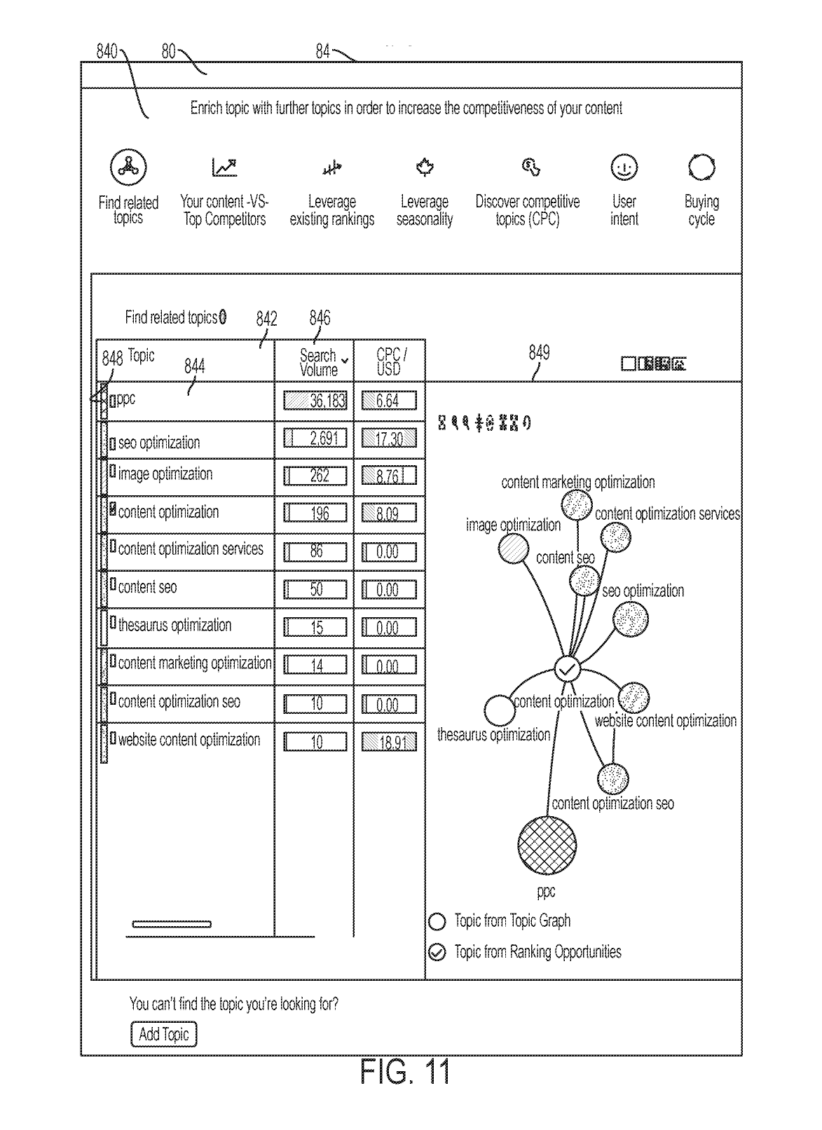

As shown in FIG. 11, the process 6, in step 630, provides a browser-capable webpage 84, comprising a corpus 840 and a top horizontal bar 80. The contents 840 comprise the topics 844 with the performance metrics 846 and input elements 848 for selecting the topics in a list 842. Further, the contents 840 may comprise a graphical representation 849 of the topics showing their relations. Further, the contents 840 may comprise lists and/or graphical representations for the other aspects such as finding related topics, comparing own contents and contents of (top) competitors, leveraging existing rankings, leveraging seasonality, discovering competitive topics, investigating user intent and investigating buying cycle. The aspects may be navigated by and displayed to the user, for example by pressing respective buttons, shown in FIG. 11, or, or selecting respective navigational tabs. Furthermore, any topic may be added by the user, for example by pressing an “Add Topic” button, shown in FIG. 11.

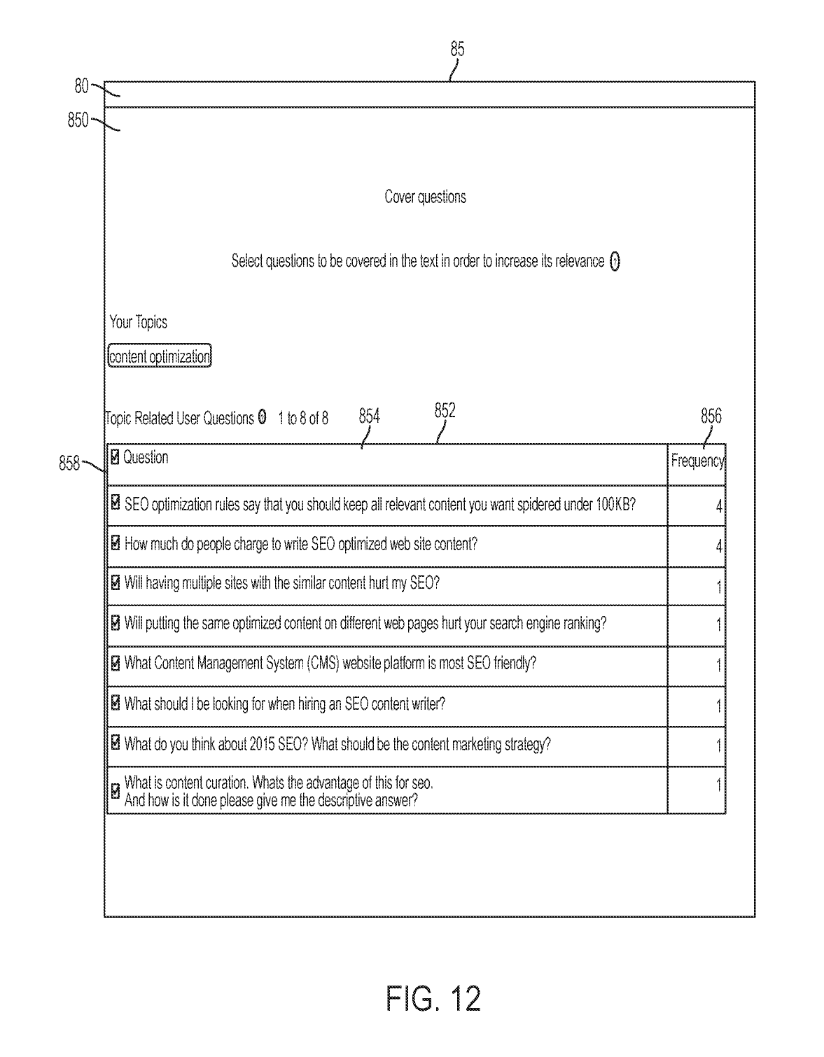

As shown in FIG. 12, the process 6 provides, in step 635, a browser-capable webpage 85, comprising a corpus 850 and a top horizontal bar 80. The contents 850 comprise the questions 854 with the performance metrics 856 such as frequency of occurrence and input elements 858 for selecting the questions in a list 852.

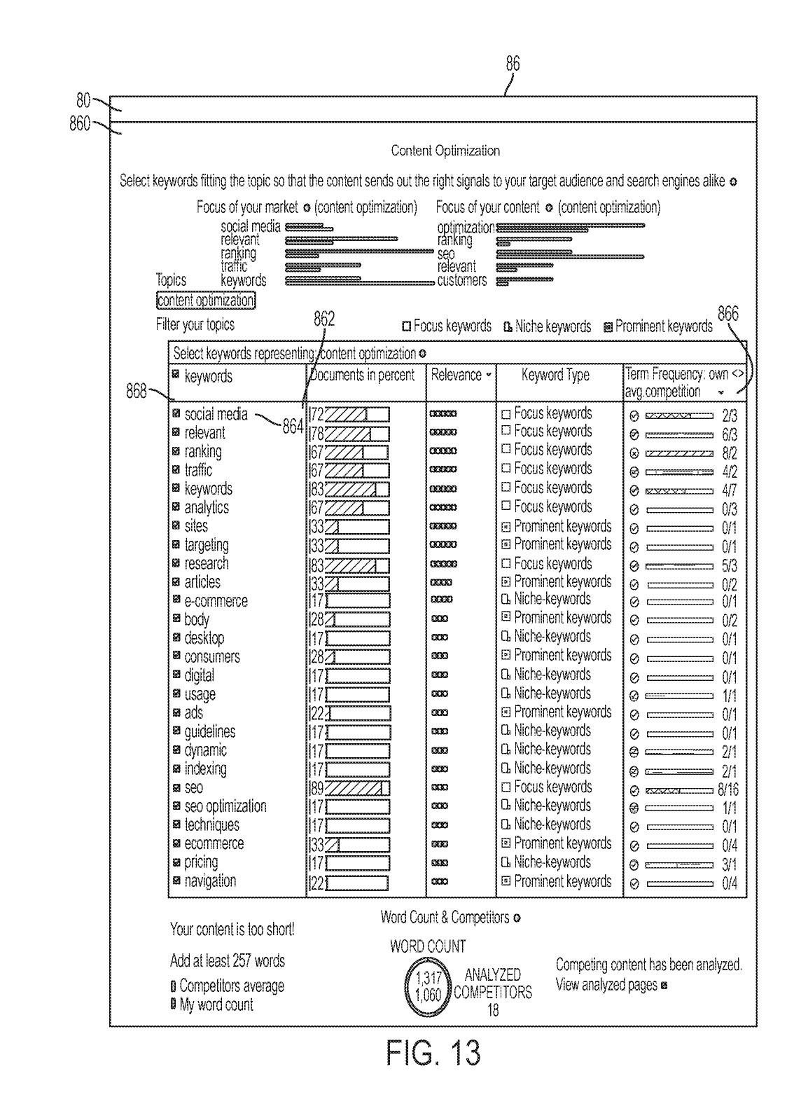

As shown in FIG. 13, the process 6 provides, in step 640, a browser-capable webpage 86, comprising a corpus 860 and a top horizontal bar 80. The contents 860 comprise the terms 864 with the performance metrics 866 and input elements 868 for selecting the terms in a list 862.

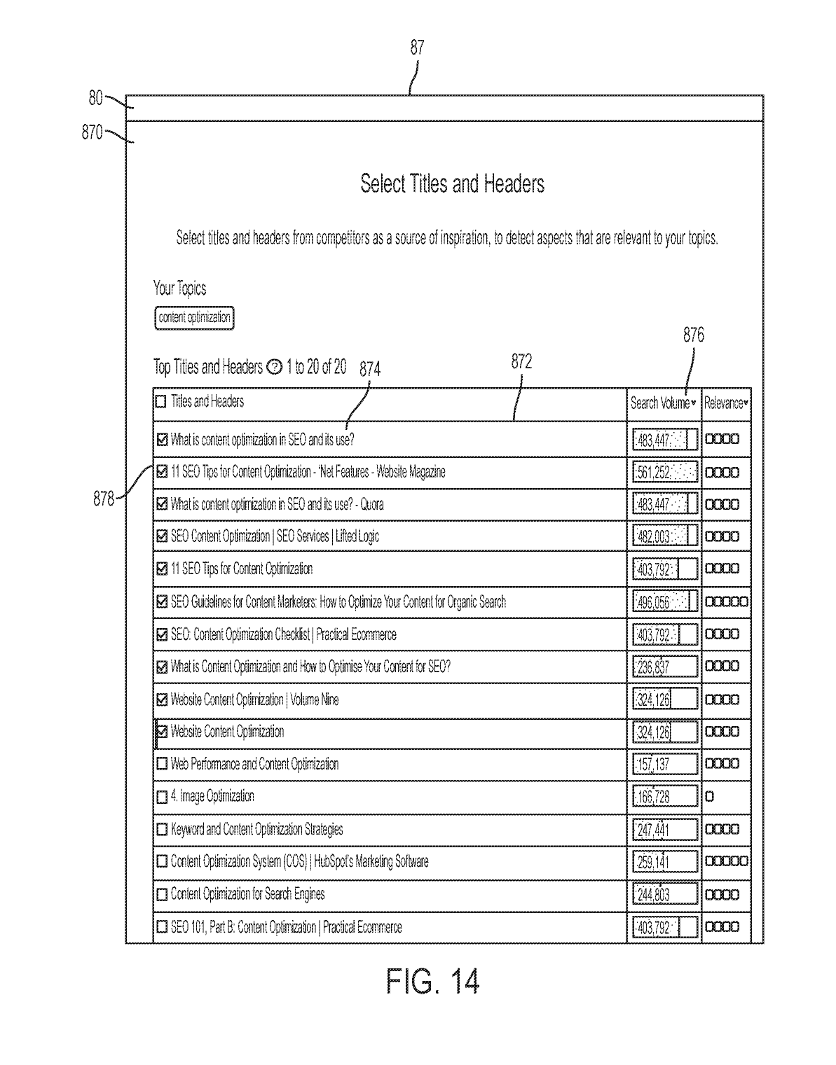

As shown in FIG. 14, the process 6 provides, in step 645, a browser-capable webpage 87, comprising a corpus 870 and a top horizontal bar 80. The contents 870 comprise the structural elements 874 with the performance metrics 876 and input elements 878 for selecting the structural elements in a list 872.

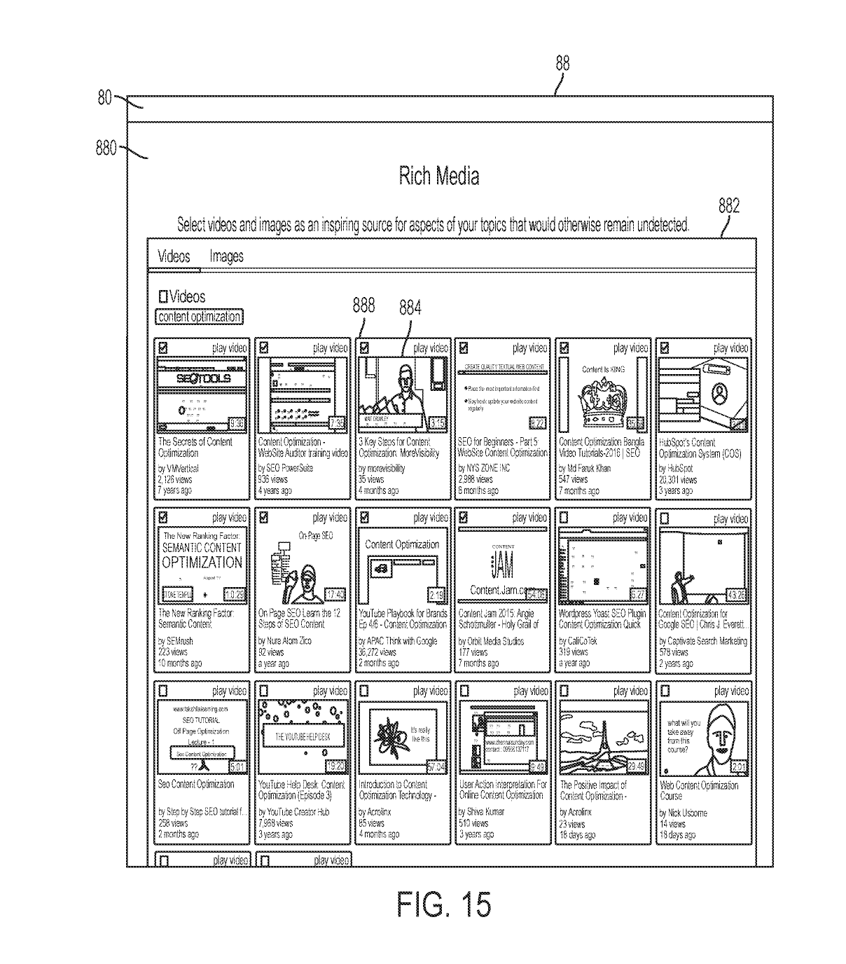

As shown in FIG. 15, the process 6 provides, in step 650, a browser-capable webpage 88, comprising a corpus 880 and a top horizontal bar 80. The contents 880 comprise the supplementary resources 884 with input elements 888 for selecting the supplementary resources in a list 882. The supplementary resources may be previewed.

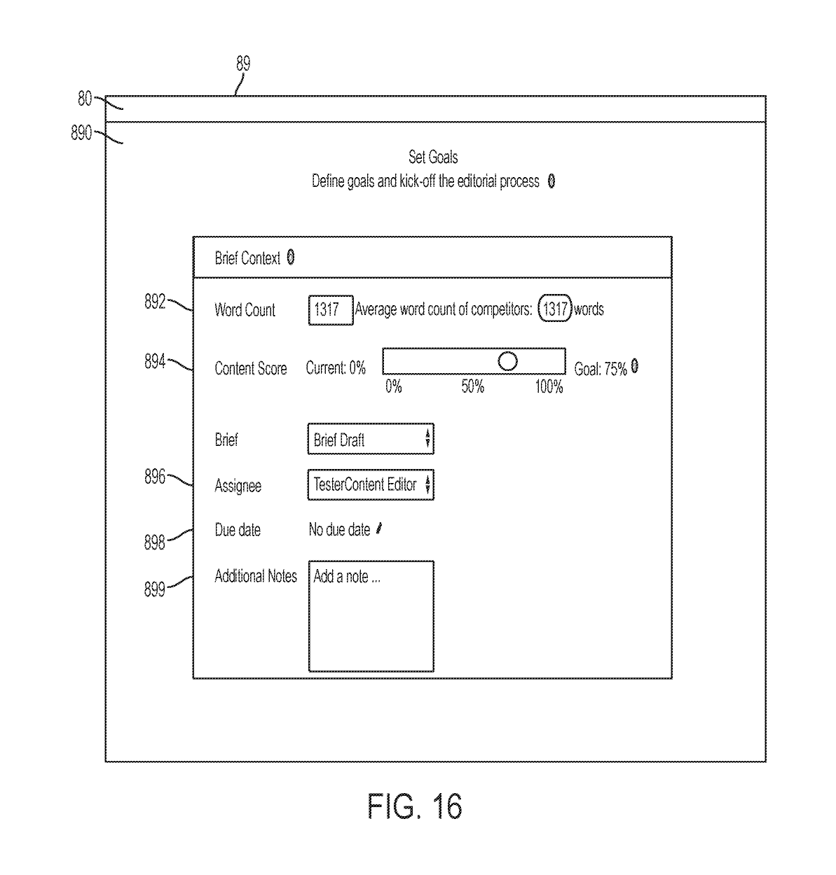

As shown in FIG. 16, the process 6 provides, in step 655, a browser-capable webpage 89, comprising a corpus 890 and a top horizontal bar 80. The contents 890 comprise the target quantity 892, target quality 894, preferred writer 896, due date 898 and additional notes 899.

The embodiments described herein are exemplary and explanatory, and are not restrictive of the invention as defined in the claims.

1-26. (canceled)

27. A computer-implemented method of creating or optimizing resource contents, comprising the steps of:
a) receiving an input from a user including one or more topics;
b) automatically determining, using pre-stored performance metrics, one or more candidate topics related to the one or more topics for the resource contents using a topic module executed on one or more computing devices;
c) automatically determining, using the pre-stored performance metrics, one or more candidate questions relevant to at least one of the one or more received topics using a question module executed on the one or more computing devices;
d) receiving one or more questions selectable from the one or more candidate questions as input from the user;
e) automatically determining, using the pre-stored performance metrics, one or more candidate terms relevant to at least one of the one or more received topics and the one or more received questions by a term module executed on the one or more computing devices;
f) receiving one or more terms inputted by the user and selectable from the one or more candidate terms;
g) automatically determining an average contents length for a similar resource contents based upon similar content of between 10 and 50 existing webpages that are among the highest ranking webpages as ranked by search engines in organic search results for relevant keywords, by a target module executed on the one or more computing devices, and based upon the pre-stored performance metrics for resource contents of one or more other users competing with the user;
h) applying a target contents length selection rule for the resource contents, by the target module, that a target contents length be between 65% and 85% of the average contents length of the similar resources content for determining a target contents length;
i) automatically generating and providing a brief to the user for the resource contents based on at least one of the one or more received topics, received questions, received terms, and which includes the target contents length, wherein the brief is generated by a brief module executed on the one or more computing devices;
j) receiving content input that meets and does not exceed the target contents length; and
k) monitoring compliance with the target contents length in real-time, while the user is creating or optimizing resources content.

28. The method of claim 27, comprising steps of:
a) acquiring contents from existing resources on a network based on the one or more received topics;
b) determining performance metrics characterizing the contents from the existing resources;
c) storing the performance metrics on a database within the network to form the pre-stored performance metrics;
d) determining a plurality of keywords from the performance metrics for the existing resources related to the resource, wherein the performance metrics are extracted from the database within the network;
e) selecting one or more keywords from the plurality of keywords; and
f) receiving one or more inputs related to the resource contents, wherein the one or more inputs include an identifier to an existing resource accessible over the network.

29. The method of claim 27, wherein the target contents length is a target word length.

30. The method of claim 28, wherein the target contents length is a target word length.

31. The method of claim 27, comprising a step of determining terms for the at least one of one or more topics, one or more questions, and one or more terms using tf-idf analysis or Word2Vec modelling.

32. The method of claim 27, comprising a step of determining terms for the at least one of one or more topics, one or more questions, and one or more terms using Word2Vec modelling.

33. The method of claim 28, comprising a step of determining terms for at least one of the one or more received topics, one or more received questions, and the one or more received terms using tf-idf analysis or Word2Vec modelling.

34. The method of claim 28, comprising a step of determining terms for at least one of the one or more received topics, the one or more received questions, and the one or more received terms using Word2Vec modelling.

35. The method of claim 29, comprising a step of determining terms for at least one of the one or more received topics, the one or more received questions, and the one or more terms using tf-idf analysis or Word2Vec modelling.

36. The method of claim 29, comprising a step of determining terms for at least one of the one or more topics, the one or more questions, and the one or more terms using Word2Vec modelling.

37. The method of claim 27, with a project module, executed on the one or more computing devices, automatically:
(a) receiving a project identifier identifying a project associated with the resource contents;
(b) receiving the one or more topics related to the resource contents;
(c) receiving a market identifier identifying an intended market for the resource contents; and
(d) determining existing resource contents based on the received one or more topics.

38. The method of claim 27, with the question module and using the pre-stored performance metrics, automatically:
(a) filtering the one or more determined candidate questions;
(b) ranking the one or more determined candidate questions; or
(c) grouping the one or more determined candidate questions around the one or more received topics.

39. The method of claim 27, wherein the pre-stored performance metrics comprise:
(a) at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate; or
(b) one or more context-related performance metrics relating to one or more contextual networks.
